(19) United States
(12) Patent Application Publication
(10) Pub. No.: US 2012/0028080 A1
(43) Pub. Date: Feb. 2, 2012

(54) PORTABLE ELECTRONIC DEVICE WITH HEATER SYSTEM

(76) Inventor: Patrick W. Truitt, Mars, PA (US)

(21) Appl. No.: 12/848,609

(22) Filed: Aug. 2, 2010

(51) Int. Cl. H01M 10/50; H01M 8/04

(52) U.S. Cl. 429/7; 429/434

(57) ABSTRACT

A portable electronic device includes a body for housing processing circuitry, the body configured for being carried or worn by a user. A battery is coupled with the body for providing power to the processing circuitry. A flexible heater unit is disposed adjacent to the battery, the flexible heater unit is operable to generate heat when powered to transfer heat to the battery. A photonic power source is configured for being carried or worn by a user and operatively coupled with the flexible heater unit to provide electrical power to the flexible heater unit.

### TECHNICAL FIELD

This invention relates generally to portable electronic devices, and more particularly, to such devices that are suitable for use in extreme or cold environments.

### BACKGROUND

Portable electronic devices have become nearly ubiquitous in all facets of modern life. Portable or mobile computers, cellular telephones, Global Positioning System (GPS) devices, portable music players, two-way radios, and many other electronic devices are typically carried by people throughout their day, sometimes for recreation, but often for work.

For example, in many different jobs, portable electronic devices have become useful tools to assist a worker in the performance of their job. One such useful product is the TALKMAN® product available from Vocollect of Pittsburgh, Pa. The TALKMAN® product is a voice or speech-based portable computer device that interacts and communicates with a remote central system, and provides a speech dialog with a worker for directing them in the performance of various work tasks. Such a portable computer device is carried by a worker who interfaces with the device using speech, such as through a headset. Portable electronic devices are generally battery-powered to provide the desired portability or mobility, and are carried in various work environments during their use.

In certain environmental conditions, and more specifically very cold conditions, the batteries that provide power to these portable electronic devices lose their effective charge level more quickly over time. Therefore, in such environments, the life span of the batteries for a portable device is significantly limited. For example, in using a portable computer device within a speech-based system, a worker might be directed to move around to fill an order, re-stock an item, or generally manage the flow of inventory in a large facility, such as a distribution warehouse. Such speech-based systems are often utilized in filling orders for the distribution of food, such as from a centrally-located warehouse to a plurality of nearby supermarkets. For certain food items, workers will be utilizing their portable devices within refrigerator or freezer environments. As such, portable electronic devices and their batteries are exposed to the very low temperatures in those environments. However, in ambient temperatures below zero degrees Fahrenheit, many of the most current batteries (typically lithium-ion batteries) used in portable electronic devices cannot carry an effective charge for significant amounts of time.

Consequently, it is desirable to maintain a suitable temperature for the power sources and batteries of portable electronic devices to ensure their proper operation in cold environments. Conventional heating devices for such use include additional battery-operated heating devices; however, those devices require their own power source. Manually-actuated heating devices that heat based on an exothermic reaction caused by manual interaction with the heating device may be used as well, but those are generally disposable, and not re-usable. Additional batteries that are made to maintain a charge in subzero temperatures are typically much heavier than the lithium-ion batteries used in portable electronic devices. These various solutions to loss of battery life in cold conditions are undesirable solutions because they require constant manual interaction over what may be a period of hours, or are much heavier than the original portable electronic device. Additionally, many of these conventional heating devices are typically not reusable, which increases the overall cost of operating these portable electronic devices.

It is thus desirable to improve on the operational life of portable electronic devices and particularly to improve on operational life of their power sources in extreme or cold conditions.

### SUMMARY

A portable electronic device includes a body for housing processing circuitry wherein the body is configured for being carried or worn by a user. A battery couples with the body and provides power to the processing circuitry. A flexible heater unit is disposed adjacent to the battery and generates heat when powered to transfer heat to the battery. A portable photonic power source configured for being carried or worn by a user and operatively coupled with the flexible heater unit to provide electrical power to the flexible heater unit. The flexible heater may include at least one resistive heating element. The photonic power source might include a solar panel. In one embodiment, the portable photonic power source is worn or carried by a user along with the portable electronic device.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is an illustration of a jacket incorporating one embodiment of the present invention.

FIG. 1A is a schematic of processing circuitry implemented in an embodiment of the invention.

FIG. 2 is a partially disassembled perspective view of the embodiment of FIG. 1.

FIG. 3 is a partially disassembled perspective view of another embodiment.

FIG. 4 is a top view of the embodiment of FIG. 3.

FIG. 5 is a partially disassembled perspective view of another embodiment.

FIG. 6 is a partially disassembled perspective view of another embodiment.

### DETAILED DESCRIPTION OF EMBODIMENTS OF THE INVENTION

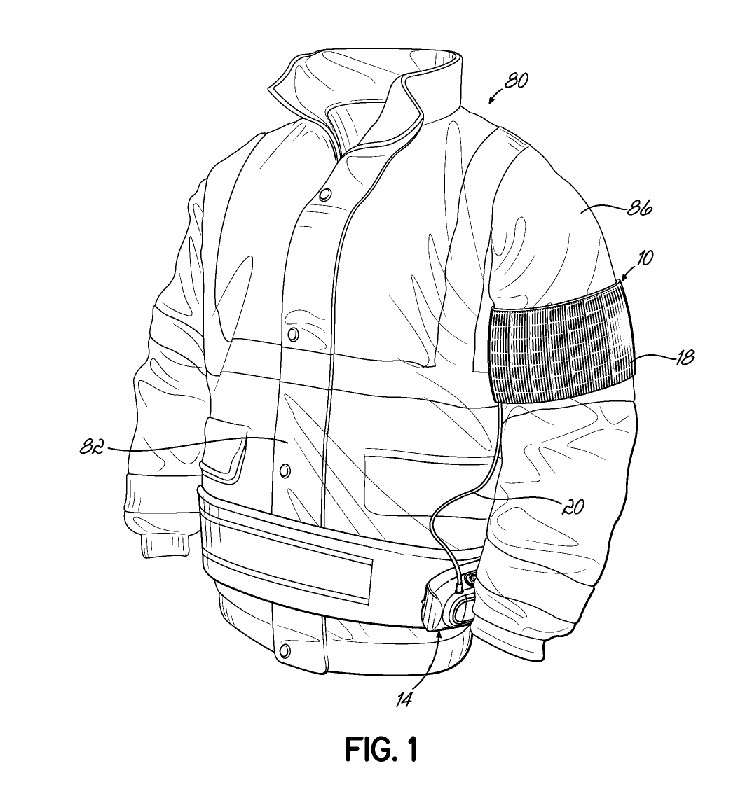

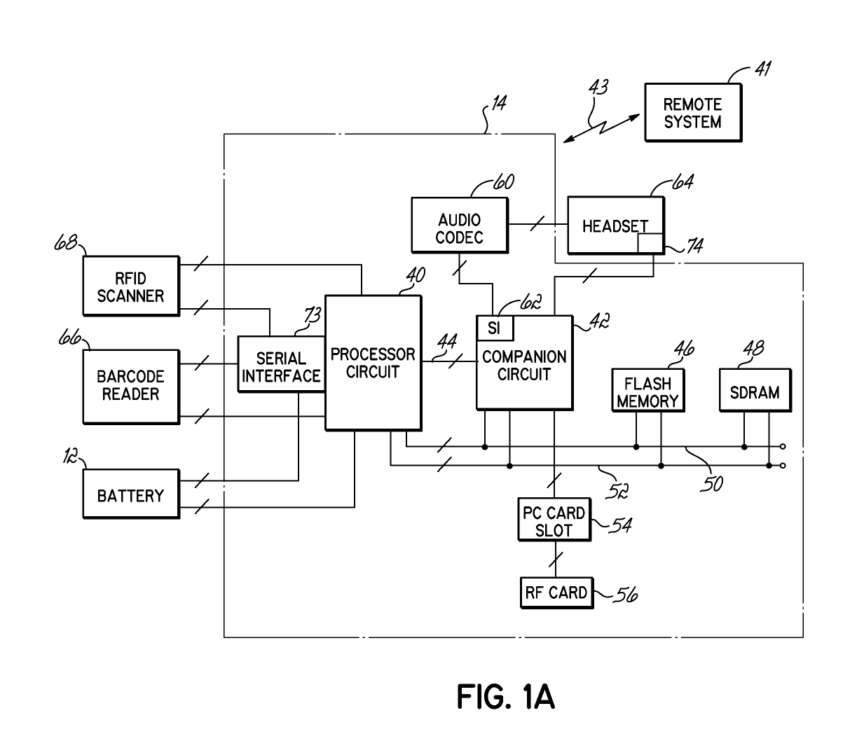

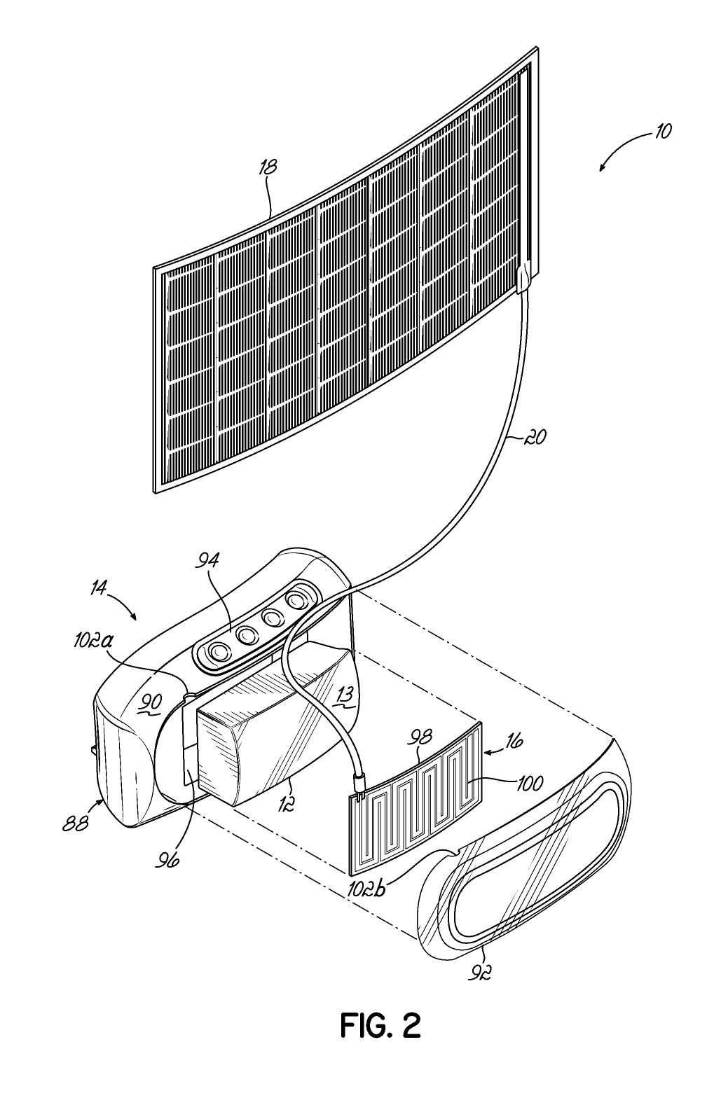

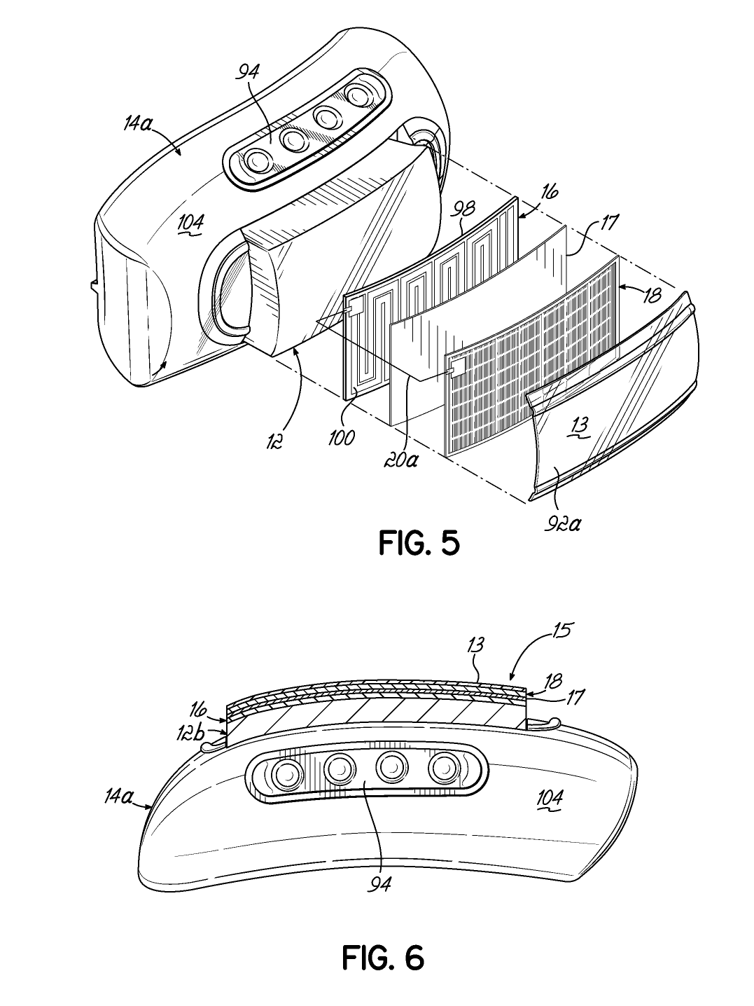

Referring to FIGS. 1 and 2, one embodiment of the invention is illustrated, including a portable electronic device 14, with a heating device 10 for heating a battery 12 of the portable electronic device 14. The heating device 10 illustrated in FIGS. 1 and 2 includes a heater unit 16 and a photonic power source 18. The photonic power source converts light into electrical power. One example of a suitable photonic source is a solar panel. As shown most clearly in FIG. 2, the heater unit 16 is disposed adjacent to the battery 12, and in thermal contact with the battery such that heat is delivered directly to the battery 12 from heater unit 16. The portable solar panel 18 in one embodiment is operatively coupled to the heater unit 16 via a suitable electrical cord or cable 20. Alternatively, solar panel 18 might be coupled more directly with heater unit 16, as discussed below with FIGS. 5 and 6. Thus, the portable solar panel 18 produces electrical power and delivers this power to actuate the heater unit 16, thereby warming the battery 12. The invention might be used with a portable electronic device 14, such as a TALKMAN® product available from Vocollect, Inc. of Pittsburgh, Pa., or a portable computer, as disclosed in U.S. Pat. No. 7,734,361, which is incorporated by reference herein in its entirety.

Battery 12 may be any suitable battery for powering a portable electronic device. Battery 12 may be a rechargeable battery. Such batteries normally include one or more fuel cells, such as electrochemical cells to convert chemical energy into electrical energy. For example, lithium-ion batteries are suitable rechargeable batteries for many portable electronic devices.

FIG. 1A is a block diagram of one exemplary embodiment of a portable electronic device for incorporating the invention. Specifically, the device 14 is configured for communicating with a worker or other user and a remote system 41 or remote computer or server, such as a system running an inventory management system, or any other system with which a worker might need to communicate. The remote system 41 might utilize one or more different computers and/or servers. The device 14, in one embodiment, is configured for providing speech communication with the worker and between the worker and remote system 41, such as a speech dialog to direct or assist the various work tasks of the worker using speech.

Device 14 includes suitable processing circuitry for operation and may include a processor circuit or processor 40 for controlling the operation of the device 14. As may be appreciated by a person of ordinary skill in the art, such processors operate according to an operating system, which is a software-implemented series of instructions. The processor may also run one or more application programs. For speech applications, the processor software includes applications directed to speech recognition and text-to-speech (TTS) functionality for implementing a speech dialog between the device 14 and a worker or other user of the device. In one embodiment of the invention, a main processor might be coupled to a suitable companion circuit or companion chip 42 by appropriate lines 44. The processor 40, and any companion circuit, are coupled to appropriate memory, such as flash memory 46 and random access memory (SDRAM) 48. The processor and companion chip 40, 42, are coupled to the memory 46, 48 through appropriate busses, such as 32 bit parallel address bus 50 and data bus 52.

To provide wireless communication 43 between the device 14 and a remote system 41, the device 14 also utilizes a PC card slot 54, so as to provide a wireless Ethernet connection, such as an IEEE 802.11 wireless standard. A suitable RF communication card 56 might be coupled with the slot 54 to provide communication between device 14 and a remote system, depending on the hardware required for the wireless RF connection.

A peripheral, such as a headset 64, might be coupled to the device 14 for speech communication with a worker which provides hands-free voice communication between the worker and the remote system 41, such as a warehouse management system. To that end, digital information has to be converted to an audio format, and vice versa, to provide the communication between the system 41 and a worker through device 14. For example, in a typical system, the device 14 might receive digital instructions from the remote system 41 and will convert those instructions to audio to be heard by a worker. The worker will then reply, in spoken utterances or speech, and the audio reply will be converted to a useable digital format and recognized, and any data communicated back to the remote system in the performance of a work task, such as for tracking inventory and order filling.

For conversion between digital and analog audio, a CODEC 60 is utilized in device 14, and is coupled through an appropriate serial interface 62 to one or both of the processors 40, 42. For example, in the embodiment illustrated in FIG. 2, the audio CODEC 60 is coupled through serial interface 62 to the companion processor 42.

Referring to FIG. 1A, a peripheral, such as headset 64, is coupled with the audio CODEC 60 for providing audio input/output, e.g., to the device 14 from the worker, and to the worker from the device. Other peripherals, such as a bar code reader 66 or an RFID scanner 68 might be coupled to an appropriate serial interface of the device 14, and specifically to a serial interface 73 of processor 40. The various peripherals provide a data collecting and communicating interface between the device 14, the worker, the remote system and the overall work environment. That is, the device 14 may collect inventory, stocking, and order filling information through a headset, bar code reader or RFID scanner, and may also provide instructions through those various peripherals as appropriate for the work being done.

A suitable battery 12 is coupled to the processing circuitry, such as processor circuit 40 for providing to the overall device 14. As will be understood by a person of ordinary skill in the art, the specifics regarding the processing circuitry and the illustrations herein are not meant to be limiting with respect to the type of portable electronic device, or portable computer device for implementing the present invention. Accordingly, the invention might be utilized with a variety of different portable electronic devices, which have a variety of different uses, where they would be exposed to extreme cold temperatures that may affect their operational life or battery life.

As shown in the embodiments of FIG. 1, the heating device 10 may be configured to be carried or worn remotely or away from the device 14. For example, it might be used with a jacket 80 or other garments appropriate for cold ambient temperatures where device 14 is used. The heater unit 16 is incorporated with the portable electronic device 14, which may be carried around and removably attached to a torso section 82 of the jacket 80. The photonic power source 18 may be a flexible solar panel such that the solar panel 18 may be coupled to or wrapped around an arm of a user, such as an arm section 86 of the jacket 22. In this arrangement, the electrical cord 20 connecting the flexible heater unit 16 and the remote solar panel 18 has a length configured to permit the arm of the user and arm section 86 of the jacket 80 to move within a normal range of motion with respect to the torso section 82. Thus, a user wearing the jacket 80 can perform any action without disrupting the operation of the heating device 10.

In the embodiment of FIGS. 1 and 2, while the solar panel 18 is remote from device 14, the heater unit 16 is generally coupled with the portable electronic device 14. In this regard, the portable electronic device 14 includes a housing case or body 88 having a main body portion 90 for receiving and housing the battery 12 and processing circuitry of the device 14, as illustrated in FIG. 1A. The main body portion 90 includes an external control panel 94 for controlling the processing circuitry and device 14. A cavity 96 in body portion 90 is configured to receive the battery 12 and the heater unit 16. The heater unit 16 might be exposed when the battery 12 is coupled with housing body 88. Alternatively, a cover plate 92 might be used for covering the battery 12 and heater unit 16 in the housing body 88.

The heater unit 16 in one embodiment is a flexible heater unit, and is formed as a thin-film member 98 etched with at least one resistive heating element 100 and encased or laminated with thin layers of insulation material (transparent in FIG. 2). Consequently, such a flexible heater unit 16 does not add any substantial weight or size to the portable electronic device 14, and is readily adapted to the surface of the battery. The battery 12 and heater unit 16 are positioned within the cavity 96 and adjacent to each other. For example, the heater unit 16 overlies the battery 12 on an exposed face surface 13 thereof. The battery cover plate 92 may be coupled to the main body portion 90 to assemble the portable electronic device 14, and help hold the battery 12 and heater unit 16 in place. The heater unit 16 is thermally coupled to battery 12, such as by contacting face surface 13. The heater unit 16 might also be separately coupled to battery 12, such as by a suitable adhesive, like a thermally-conductive adhesive. For example, in the Vocollect TALKMAN® product, battery 12 is latched into cavity 96, and stays in place without a separate cover plate 92. The heater unit may be adhered to battery 12, and, therefore, similarly held in place. Alternatively, the heater unit 16 might be captured and held between battery 12 and the cover plate 92 as noted. In the embodiment, as shown in FIG. 2, the main body portion 90 and the cover plate 92 include cooperating notches 102a, 102b that form an aperture for the electrical cable 20 to pass through the assembled body 88. It will be appreciated that a notch for the electrical cable 20 could alternatively be formed in only the main body portion 90 or only the cover plate 92, in other embodiments if necessary to accommodate cable 20.

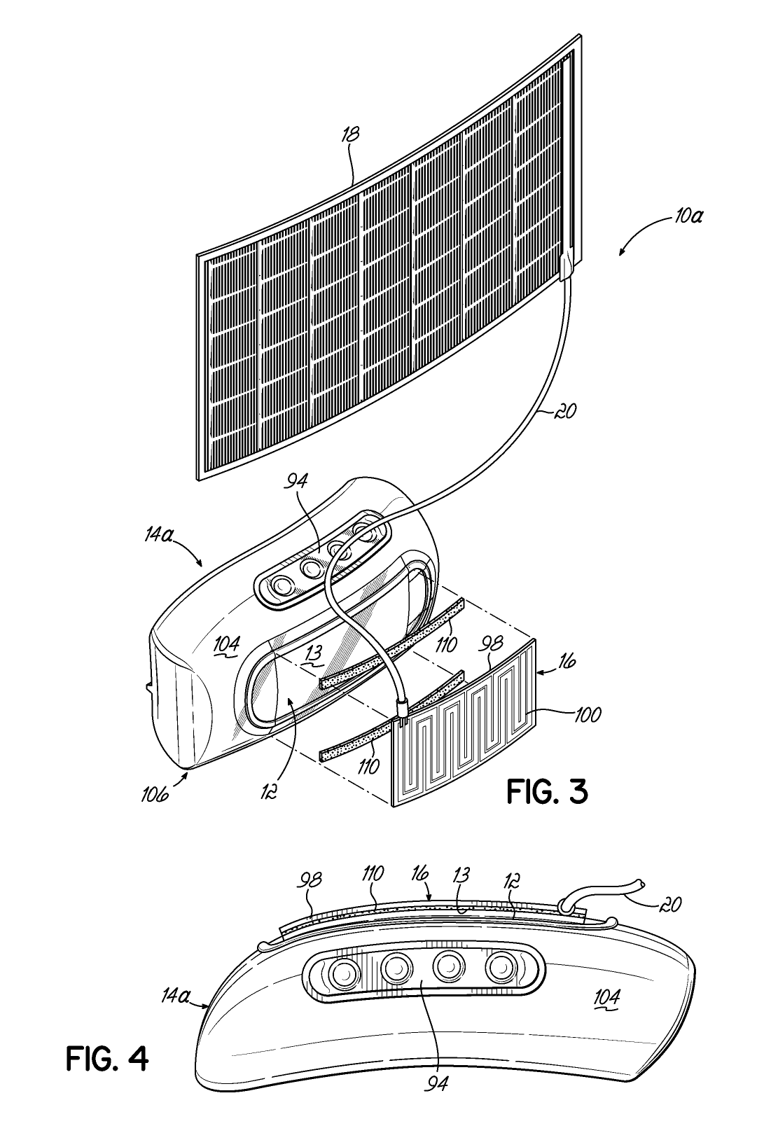

FIGS. 3 and 4 illustrate another embodiment of a heating device 10, with identical reference numbers used for identical elements from the previous described embodiment. In this embodiment, the battery 12 is latched into body 88 includes an outer face surface 13. The battery 12 is shaped and configured so that the face surface 13 cooperates with body portion 104 of the device housing body 106 of the portable electronic device 14a. The heater unit 16 is appropriately and thermally attached to the outer surface 13 of the battery 12. For example, adhesive material 110, such as pressure-sensitive adhesive materials, might be used. FIG. 3 illustrates adhesive material strips, but a layer of adhesive material 110 also might be used. The adhesive material 110 is pressure-sensitive such that the flexible heater unit 16 can be easily coupled to the portable electronic device 14a. Thus, the heater unit 16 is positioned on the outer body portion 104 adjacent to or over the battery 12 to thermally deliver heat to the battery 12. In the embodiment of FIGS. 2 and 3, the heat is generated from the power delivered through electrical cable 20 from the portable solar panel 18. The heating devices 10, 10a of the invention may be configured for use with various portable electronic devices.

One example of a flexible heater unit 16 that may be used in the heating devices 10, 10a is the Thermofoil® heater produced by Minco of Minneapolis, Minn. In this regard, the at least one resistive heating element 40 of the heater unit 16 is a flat foil element 100 that transfers heat more efficiently over a larger surface area than round wire resistive heating elements. As a result, the heater unit 16 can have a total thickness of about 0.01 inches, which does not add any significant thickness or weight to the portable electronic devices 14, 58. The flexible heater unit 16 may also be designed to have any size corresponding to the size or surface area of face surface 13 of the respective battery 12 to be warmed. Alternatively, the heater unit may be sized larger than the battery to cover some or all of the housing body of the device.

One example of a portable photonic power source 18 that may be used in the heating devices 10, 10a is an Innovative Solar Technologies® Flexible Solar Panel produced by Silicon Solar, Inc. of Bainbridge, N.Y. The flexible solar panel 18 is produced by thin-film deposition of silicon material onto a flexible substrate of polyethylene terephthalate (PET). The solar panel 18 can produce anywhere from 5 watts to 50 watts of power for actuating the resistive heating element 100 of the flexible heater unit 16. The combination of the solar panel 18 and the heater unit 16 is a reusable source of heat energy that does not need to be replaced after every use, like some conventional battery heating devices.

Accordingly, in one embodiment of the invention, the electronic devices are worn by a user working within a cold temperature environment, such as a refrigerator or a freezer. Generally, such areas will be illuminated by suitable light sources, which provide light energy to be captured by the portable solar panel 18. Solar panel 18, as illustrated in FIG. 1, would be worn so as to be exposed to such light sources as the worker moves around throughout the cold work space. The solar panel 18 absorbs light energy from such light sources and converts it to electrical energy for powering flexible heater unit 16.

As illustrated in the embodiments of FIGS. 2 and 3, the solar panel or other portable photonic power source 18 is remote from the portable electronic devices 14, 14a, and remote from the heater unit 16, which it powers. The length of cable 20 provides such a remote adaptation. The remote location may be necessary for power source 18 to obtain and capture as much light energy or photonic energy as possible, so that it provides the desired power to heater unit 16. For example, portable computer devices 14, 14a might be worn around the torso of a user, and might be covered by clothing such as the jacket illustrated in FIG. 1. Therefore, it is desirable to position power source 18 in an exposed area, such as around the outside of any clothing, such as a jacket, in order to be exposed to the light source.

In an alternative embodiment, a portable device, such as device 14a, might be worn in a sufficient location to be exposed to sufficient natural or artificial light of the work environment, such as a refrigerator or freezer. To that end, as illustrated in FIGS. 5 and 6, the photonic power source 18 might be located more proximate to the heater unit 16. For example, photonic power source 18, such as a flexible solar panel, might overlie the heater unit 16, and be coupled by an appropriate electrical connection or conductor 20a. Power source 18 might be appropriately secured to heater unit 16, such as with a suitable adhesive, and may be sized accordingly with respect to heater unit 16, for proper arrangement over battery 12 on the portable device 14a. Depending upon the heat generated by flexible heater unit 16, an insulation layer 17 might be incorporated between power source 18 and the flexible heater 16 for protecting the power source 18 while heat is being generated to warm or heat the battery 12. The heater unit 16 and power source 18 might then be coupled as a unit to battery 12 utilizing a suitable pressure-sensitive adhesive material. A transparent cover plate 92a might go over all layers to define a face surface 13.

In still another embodiment, as illustrated in FIG. 6, portable photonic power source 18 and flexible heater unit 16 might actually be incorporated into a single housing with the battery 12. That is, the layers provided by the photonic power source 18 and heater unit 16 are integral with or integrally contained in the housing 15 of the battery 12, as appropriate, as illustrated in FIG. 6. It would be understood that any housing 15 for battery 12 must have a transparent face surface 13 for exposing the photonic power source 18 to a source of light. Turning to FIG. 6, one embodiment in the invention might incorporate a battery 12b having various of the elements disposed as layers and integrally contained in a common battery housing. For example, a housing might contain at least one fuel cell, as is conventional. A flexible heater layer integrally contained in or with the battery housing may be operable to heat when powered to transfer heat to the housing and the fuel cell. The photonic power source layer might be integrally contained in or with the battery housing, and coupled with a flexible heater layer to provide electrical power to the flexible heater layer to heat the battery. The layers all cooperate in a single housing. As illustrated in FIG. 6, the photonic power source layer would have to be exposed proximate an outside surface, such as proximate to or at the face surface 13 of the battery 12b or battery housing 15 to absorb light energy through the transparent face surface, and thus, power the heater layer.

In an exemplary operation, the heating device 10 may be used to raise the temperature of a battery 12 from minus −20 degrees Celsius (where a Lithium-ion battery 12 will not hold a high effective charge) to 0 degrees Celsius (where a Lithium-ion battery 12 can hold an effective charge). Thus, assuming a typical battery mass of 0.14 kilograms, a heat capacity of 0.9 Joules/gram-Kelvin, and a heating time of 20 minutes, the power required to warm the battery to 0 degrees Celsius is 2 watts. Considering the portable solar panel 18 is capable of producing 5 to 50 watts, the heating device 10 will successfully warm the battery 12 for use in the portable electronic device 14 in subzero ambient temperatures.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A portable electronic device comprising:
a body for housing processing circuitry, the body configured for being carried or worn by a user;
a battery configured to couple with the body for providing power to the processing circuitry;
a flexible heater unit disposed adjacent to the battery, the flexible heater unit operable to generate heat when powered to transfer heat to the battery;
a photonic power source configured for being carried or worn by a user and operatively coupled with the flexible heater unit to provide electrical power to the flexible heater unit.

2. The portable electronic device of claim 1 wherein the processing circuitry is operable for providing speech communications between a user and a remote system.

3. The portable electronic device of claim 1 wherein the flexible heater unit includes at least one resistive heating element.

4. The portable electronic device of claim 3, the flexible heater unit including a thin-film etched with the at least one resistive heating element, the thin-film encased with layers of insulation material.

5. The portable electronic device of claim 1, wherein the flexible heater unit is contained in the body of the portable electronic device.

6. The portable electronic device of claim 1 wherein the photonic power source includes a solar panel.

7. The portable electronic device of claim 1 wherein the photonic power source is flexible.

8. The portable electronic device of claim 5 further comprising a cover plate for covering a battery coupled with the body, the flexible heater unit being held in the body between the battery and cover plate.

9. The portable electronic device of claim 1, wherein the flexible heater unit is coupled to the battery.

10. The portable electronic device of claim 9, wherein the flexible heater unit is adhered to the battery with a pressure-sensitive adhesive material.

11. The portable electronic device of claim 1 wherein the flexible heater unit is integral with the battery.

12. The portable electronic device of claim 6 wherein the solar panel is a flexible solar panel.

13. The portable electronic device of claim 6, wherein the solar panel is configured to be coupled to the arm of a user of the portable electronic device.

14. The portable electronic device of claim 1 wherein the photonic power source is configured to deliver at least 2 watts of power to the flexible heater.

15. The portable electronic device of claim 1, wherein the flexible heater unit is configured to be reusable.

16. A portable electronic device comprising:
a body for housing processing circuitry operable for providing speech communications between a user and a remote system, the body configured for being carried or worn by a user;
a battery configured to couple with the body for providing power to the processing circuitry;
a flexible heater unit including at least one resistive heating element and disposed adjacent to the battery, the flexible heater unit operable to heat when powered to transfer heat to the battery;
a solar panel configured for being carried or worn by a user and operatively coupled with the flexible heater unit to provide electrical power to the flexible heater unit.

17. A portable electronic device comprising:
a body for housing processing circuitry, the body configured for being carried or worn by a user;
a battery configured to couple with the body for providing power to the processing circuitry;
a flexible heater layer integral with the battery and including at least one resistive heating element and disposed adjacent to the battery, the flexible heater unit operable to heat when powered to transfer heat to the battery;
a photonic power source layer integral with the battery and positioned above and coupled with the flexible heater layer to provide electrical power to the flexible heater layer to heat the battery.

18. A battery for use with a portable electronic device comprising:
a housing;
at least one fuel cell contained in the housing;
a flexible heater layer integrally contained in the housing and including at least one resistive heating element, the flexible heater layer operable to heat when powered to transfer heat to the housing and at least one fuel cell;
a photonic power source layer integrally contained in the housing and coupled with the flexible heater layer to provide electrical power to the flexible heater layer to heat the battery, the photonic power source layer exposed on an outside surface of the housing to absorb light energy.
